(19) United States
(12) Patent Application Publication
(10) Pub. No.: US 2014/0102308 A1
(43) Pub. Date: Apr. 17, 2014

(54) BREWING UNIT FOR A COFFEE MACHINE

(71) Applicants: Christian KOESTER, Warstein-Hirschberg (DE); Joerg Krug, Steffenberg (DE); Klaus Kroesen, Xanten (DE)

(72) Inventors: Christian KOESTER, Warstein-Hirschberg (DE); Joerg Krug, Steffenberg (DE); Klaus Kroesen, Xanten (DE)

(21) Appl. No.: 13/650,299

(22) Filed: Oct. 12, 2012

(51) Int. Cl. A47J 31/44

(52) U.S. Cl. CPC A47J 31/4403
USPC 99/287

(57) ABSTRACT

A brewing unit for a coffee machine has a brewing cylinder on a second end of which an end plate is pivotal between a closed position and an open position. A piston is axially movable in the cylinder away from the first end of the cylinder past the fill opening to compact coffee introduced through a fill opening at the second end in a brewing position and from the brewing position toward the second end in the open position of the end plate into an eject position to eject the used ground coffee from the brewing chamber. A pair of gear wheels flank the cylinder at the second end. Respective coupling plates each having an inner end pivoted on a respective one of the wheels and an outer end pivoted on the end plate about an actuating axis. A drive synchronously rotates both wheels.

### FIELD OF THE INVENTION

The present invention relates to a coffee machine. More particularly this invention concerns a brewing unit for a coffee machine.

### BACKGROUND OF THE INVENTION

A brewing unit for a coffee machine, in particular for making espresso, comprises a brewing chamber that holds ground coffee including components to compact ground coffee in the brewing chamber and to eject wet residual coffee grounds from the brewing chamber. Connections are provided to supply hot water and to drain the filtrate. The brewing chamber is formed by a fixed cylinder that has a fill opening for ground coffee on an upper side near its first end and a piston axially movable by a first actuator at the first end of the cylinder serving to compact the ground coffee poured into the brewing chamber. The piston when in the fill position unblocking the fill opening and being moved in the brewing position beyond the fill opening by a second actuator toward an end plate provided at the second end of the cylinder. This plate closes the second end of the cylinder in the fill position and in the brewing position and unblocks the second end of the cylinder in the eject position. The piston when in the eject position is movable toward the second end of the cylinder by the first actuator to an eject position when the end plate is set in the open position. The piston and the end plate be being set back to the starting position after ejecting the wet residual coffee grounds. The connections for the hot water supply and filtrate drain are provided on the end plate and the piston.

A brewing unit of this type has been described, for example, in DE 10 2007 042 379.

In the known arrangement, which has proven successful in practical use, a disadvantage has been observed in the fact that contamination can occur in a coffee machine even when the brewing unit is used properly, which contamination can interfere with the actuating mechanism of the brewing unit. It has furthermore been found that the end plate is unintentionally misaligned under certain circumstances when brewing pressure is applied in the brewing chamber, or that gears that are connected to the end plate are overloaded, thereby allowing excessive wear to occur over time.

### OBJECT OF THE INVENTION

Based on this prior art, the object of this invention is to create a brewing unit of the described kind in which operationally related contamination of the actuation mechanism and the like is avoided to the greatest extent possible, and in which excessive wear of the actuation means for the end plate is also prevented.

To achieve this object, the invention proposes pivoting the end plate externally on the cylinder near the cylinder's second end so it can be pivoted about this pivot from a closed position to an open position. Compartments closed by covers are provided laterally on opposite sides outside the cylinder. Each compartment holds a respective rotatable gear wheel that meshes with a common gear drive shaft supported in a housing pocket and having a drive coupling projecting axially out of the housing pocket. Respective coupling plates are pivoted at one end on the gear wheels eccentrically at second eccentric pivots, each extend through a radial slot of the respective compartment, and are pivoted at third actuating pivots by opposite ends projecting from the slots externally on the end plate opposite the piston, at a spacing from the first pivot of the end plate on the cylinder. The second eccentric pivot and the third actuating pivots and the rotation axes of the gear wheels lie in the closed position on an imaginary straight line that runs parallel to a longitudinal central axis of the cylinder.

In contrast to the prior art, the end plate is not pivoted to a piston rod, but instead is pivoted to the cylinder externally near the cylinder's second end and is pivotal about this pivot. In order to execute the pivot motion, the gear wheels and a gear shaft are provided, each of which is encapsulated in the compartments that are integrally molded onto or provided externally on the cylinder. Only a coupling end of the gear shaft functioning to connect to the drive motor projects from the housing pocket that accommodates the gear shaft. In order to actuate the end plate, coupling plates pivoted eccentrically to the gear wheels each project through a radial slot of the compartments in which the gear wheels are provided, the coupling plates being pivoted at one end section to the end plate at a certain spacing from the first pivot. This design and embodiment whereby the second and third pivots, and the rotational axes of the gear wheels, are located in the closed position on an imaginary straight line running parallel to the longitudinal central axis of the cylinder achieves the result that with the brewing chamber and the end plate in the closed state the piston pressure is easily resisted when applied with considerable force on the end plate since the coupling plate is located at a null point. In other words, no torque is exerted around the gear-wheel axis. In addition, the coupling plates hook a pin provided in the housing and housing cover. Actuating the drive motor enables the gear wheels to rotate, with the result that the coupling plates that are eccentrically pivoted to the gear wheels are carried along, and the end plate is forced open. When the actuation motion of the drive motor is reversed, the closed position is reached once again.

When the end plate is closed, a microcircuit provided on the support can for example be actuated by an coupling plate or a hook provided on it. This circuit is connected with a controller of the coffee machine and signals the controller that the end plate is in the correct closed position, thereby enabling the brewing chamber to be filled and flow to pass through appropriately.

An especially preferred development is one in which a scraper is slidable across the second end of the cylinder perpendicular to the center longitudinal axis of the cylinder. This scraper has driver pins projecting laterally and each engaging a cam slot provided in the respective coupling plate in such a way that the scraper is positively moved, starting with the end plate almost completely opened up to the position of the completely opened end plate from a position outside the alignment line spanned by the cylinder into a position aligned with the cylinder, with the result that any caked residue adhering to the movable piston is scraped off, and that the scraper is slid back in advance of the plate's closing motion when the end plate is pivoted back from the open position to the closed position.

This embodiment ensures that, when the end plate is opened and the caked residue is ejected, this residue is acted upon by the scraper so that any caked residue adhering to the movable piston is scraped off completely. When the movable piston advances properly to eject the caked residue, the used coffee grounds (the caked residue) are removed by the scraper by a translatory motion. In particular the scraper can be composed of a plastic lip that can move up and down through a lateral guide which is mounted at the side of the cylinder. The actuating motion can be effected by the coupling plates that guide driver pins in a cam groove, the driver pins being mounted on the scraper. The motion of the driver pins is determined by the geometry of the door-closing mechanism; but it can also be influenced by the guidance of the groove. The groove in the form of the cam slots is shaped so that the scraper moves down to perform the scraping-off action only when the end plate is almost completely opened. This prevents a collision with other components of the apparatus. The return to the base position is also ensured by the positive guidance when the end plate is again returned to the base position (to the closed position).

Another measure that serves to improve the operational reliability of the brewing unit, and clearly considered to be an independent inventive step, is the fact that a door is installed in the fill opening that is in fact a passage, which door is pivotal and can be moved from a closed position in which it blocks the passage to an open position in which it unblocks the passage. The door has a driver lever that projects into the cylinder in the closed position, and against which parts of the movable piston are pressed in the fill position and retain the door in the open position, wherein the driver lever is released in the brewing position and the door is pivoted into the locked position.

The fill position in the prior art is closed by parts of the movable piston such that a situation can arise in which coffee grounds or the like can drip through the fill opening when the movable piston is moved, thereby allowing parts of the piston or of the piston's outer surface to be contaminated by coffee grounds.

In order to prevent this, a door is installed according to the invention in the passage that forms the fill opening, which door is pivotal. The passage is closed by the door in the closed position, thereby preventing any coffee powder or the like from continuing to drip and contaminating parts of the piston or its actuation means. When the movable piston returns to the base position so as to allow the ground coffee to be poured in, the end plate is pivoted to the open position by the movable piston that engages the driver lever, thereby allowing ground coffee or the like to be supplied through the passage.

Provision is preferably made here whereby the end plate can be moved to the open position against the force of a closing spring.

For example, a coil spring can be inserted on link pins of the door, by which automatic closing of the door is effected when the door or its driver pin is released from the movable piston.

In another preferred embodiment, the axially movable piston has a coffee strainer integrally molded into the material of the piston at the end on its side facing the end plate, and has a crema valve in a piston shaft, the valve being connected to a hot water supply line.

This embodiment allows the overall length to be reduced for the piston together with coffee strainer. The piston together with integrally molded coffee strainer is attached to the piston rod, for example, screwed onto this rod, thereby simultaneously securing the crema valve inserted in the piston rod.

In another embodiment that improves operational reliability, a support in the form of a closed housing is provided in which the actuators—in particular drive motors—are provided, wherein connecting parts of the actuators emerge from a lateral surface of the support, and the brewing unit can be inserted onto the support perpendicular to the longitudinal central axis of the brewing chamber, with the result that the coupling parts for piston actuation and for end plate actuation are engaged with the connecting parts of the actuators, wherein the support has a guide into which the brewing unit can be inserted and can be slid along the support rod into the intended installation position.

In this embodiment, all of the actuators and the like, as well as the electrical connections, are provided and mounted in the support in the form of a closed housing. The brewing unit can be easily inserted onto the housing so as to secure the coupling to the drive motors, the brewing unit comprising only those parts that require cleaning and can be subject to operationally-related wear. In order to install the brewing unit, the assembly can first be placed on the support rod while resting by the other end section on a guide face of the support. The brewing unit can then be moved toward the support such that the corresponding connecting parts or coupling means are connected between the actuators and the actuated means. Once it is in the intended installation position, the complete brewing unit is ready to operate.

Provision is preferably made whereby detent-locking means or releasable attachment means are provided by which the position of the brewing unit on the support can be locked and secured.

In order to improve the operational reliability, the piston has a piston rod in the form of a threaded spindle, and a drive gear is secured to the threaded spindle by a spindle nut that engages a worm gear which can be coupled to the motor of the first actuator. All these parts are protected inside the housing of the brewing unit. A drive coupling of the worm gear projects from this housing and in the intended installation position is plugged into the drive shaft of the motor provided in a separate support housing.

In this embodiment, a drive gear is supported by a spindle nut on the piston rod provided in the form of a threaded spindle. This gear engages a worm gear ball-bearing-mounted in a housing of the brewing unit and driven by the actuator that is provided in the separate support housing. All the components are protectively provided inside the housing of the brewing unit. Only one coupling of the worm gear projects from the housing component. When in the intended installation position, this is plugged into the drive shaft of the motor provided in the support housing.

This arrangement provides an actuating unit of simple and heavy-duty construction that contributes overall to an improvement of the brewing unit.

Embodiments of the invention are shown in the drawing and described in detail below. Therein:

FIG. 1 is an oblique perspective view of the complete brewing unit;

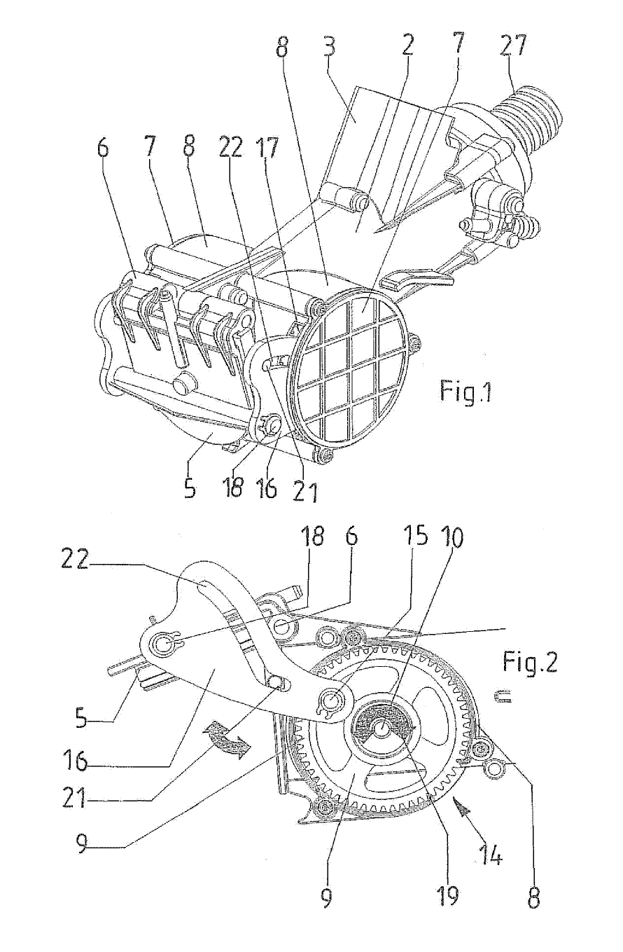

FIG. 2 is a detail from FIG. 1 providing a side view with the cover plate removed and end plate opened;

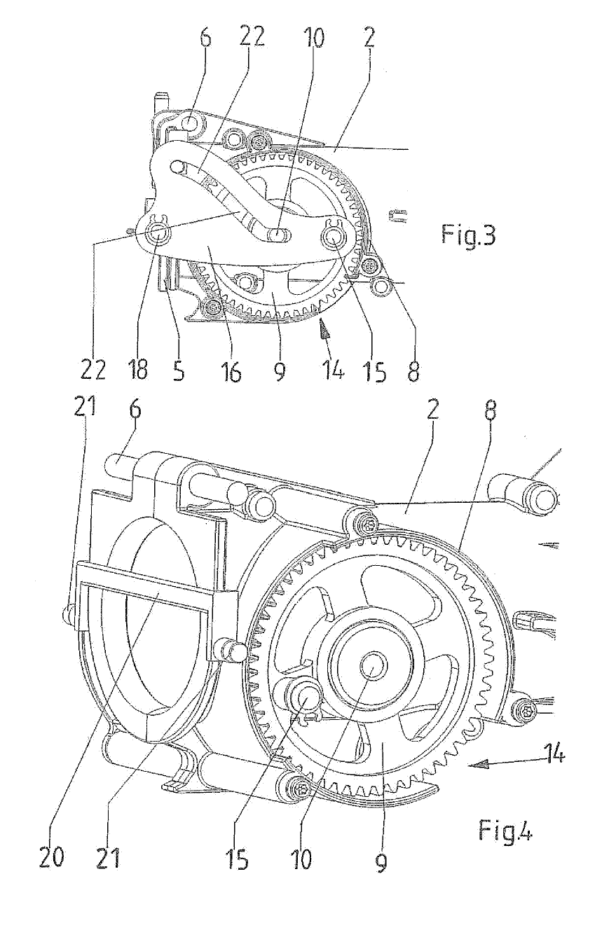

FIG. 3 shows it with the end plate closed;

FIG. 4 is an analogous view with a detail of the scraper;

FIG. 5 is a sectional view of the brewing unit when the movable piston is advanced;

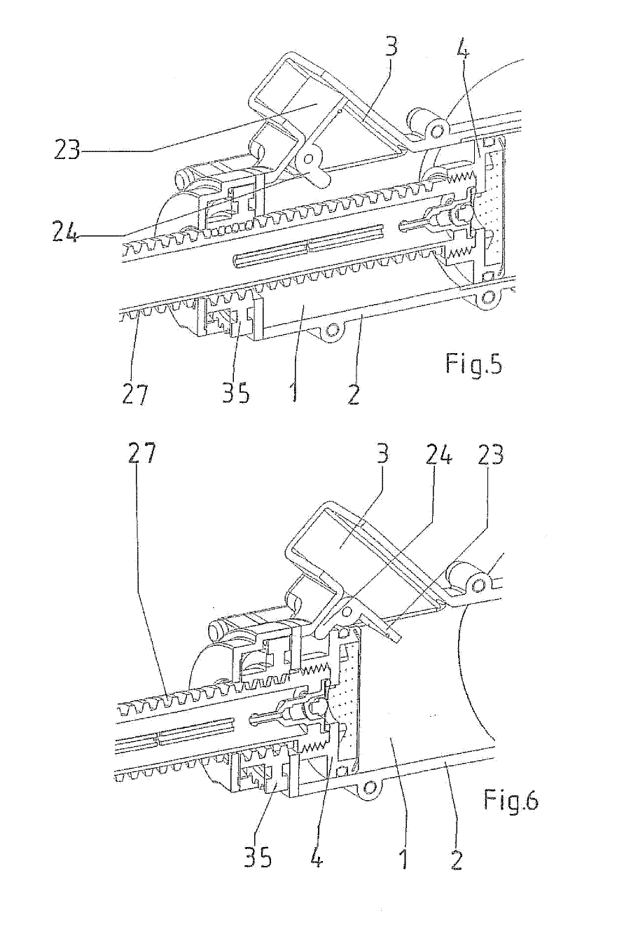

FIG. 6 shows it when the movable piston has been retracted to the rest position;

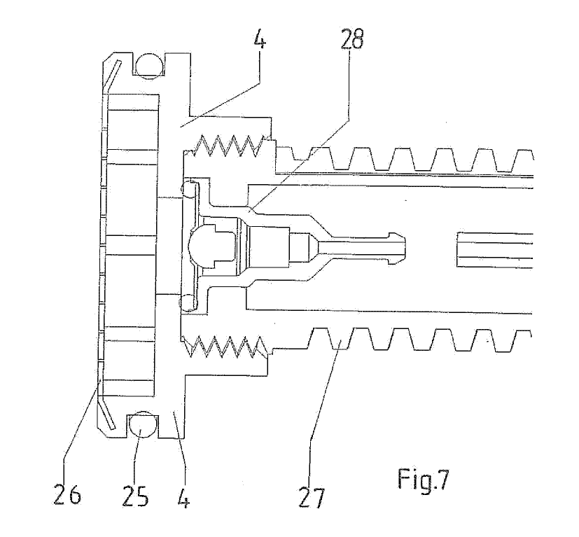

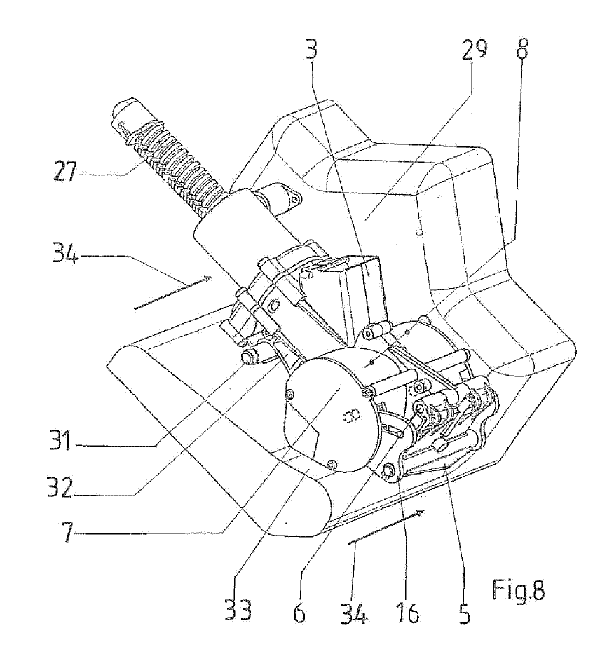

FIG. 7 is a sectional view of the movable piston;

FIG. 8 is an oblique perspective view of the brewing unit mounted on a support in the operating position;

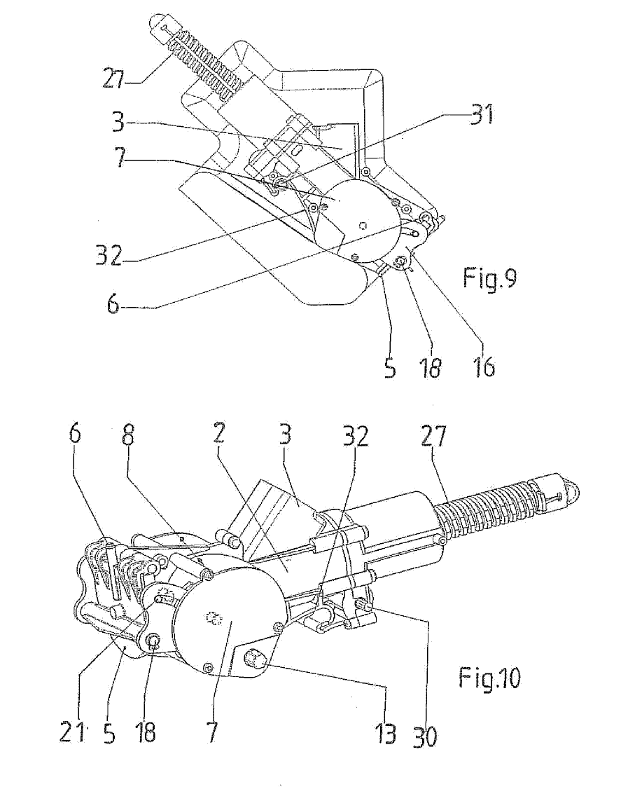

FIG. 9 is a side view of it;

FIG. 10 is a side view of the brewing unit alone;

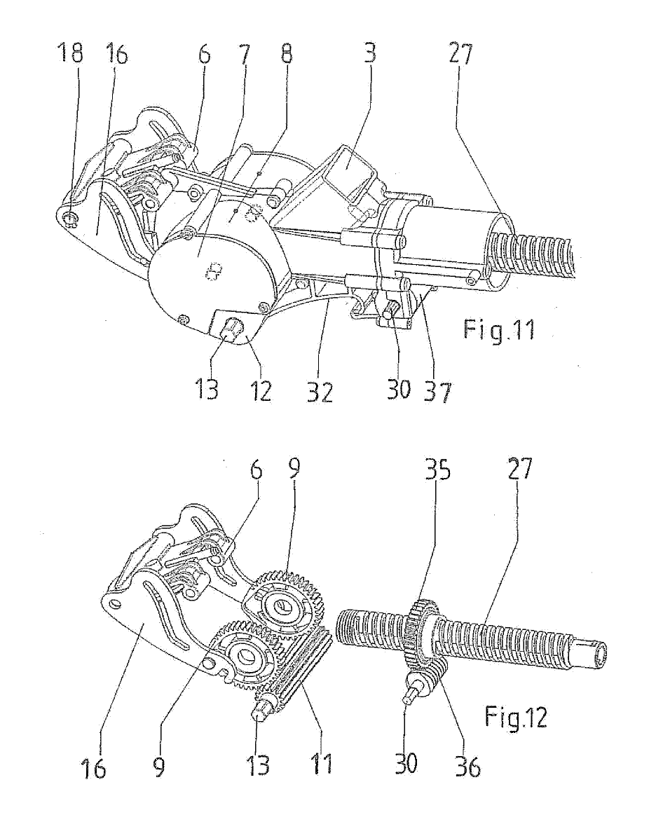

FIG. 11 is a side view of the brewing unit in another operation;

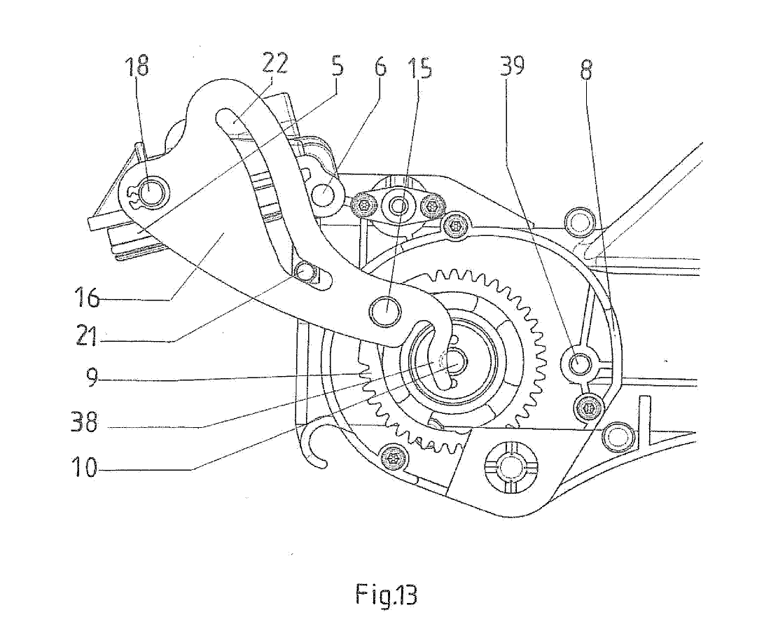

FIG. 12 is an oblique perspective view providing details of the actuating means;

FIG. 13 provides an alternative embodiment as seen in a view based on FIG. 2;

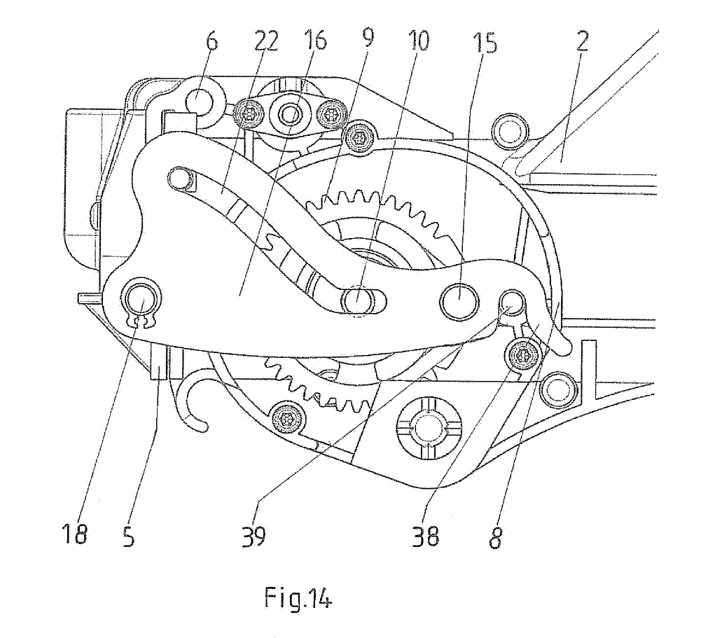

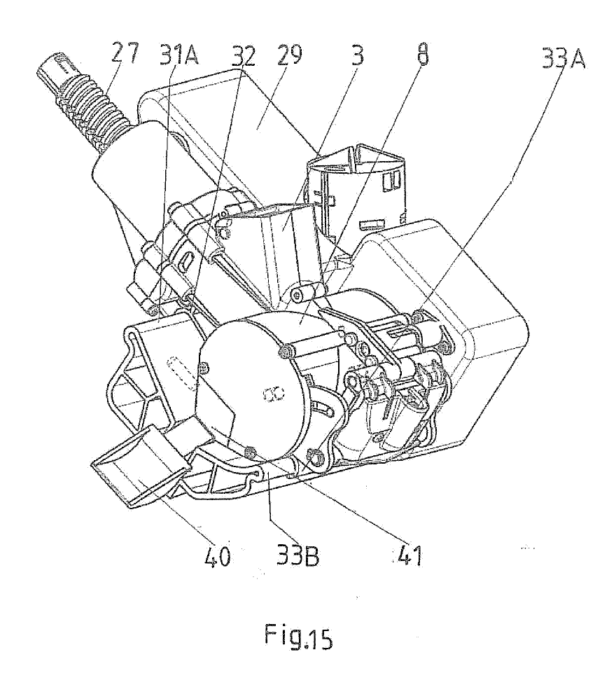

FIG. 14 shows it as seen in the view of FIG. 3;

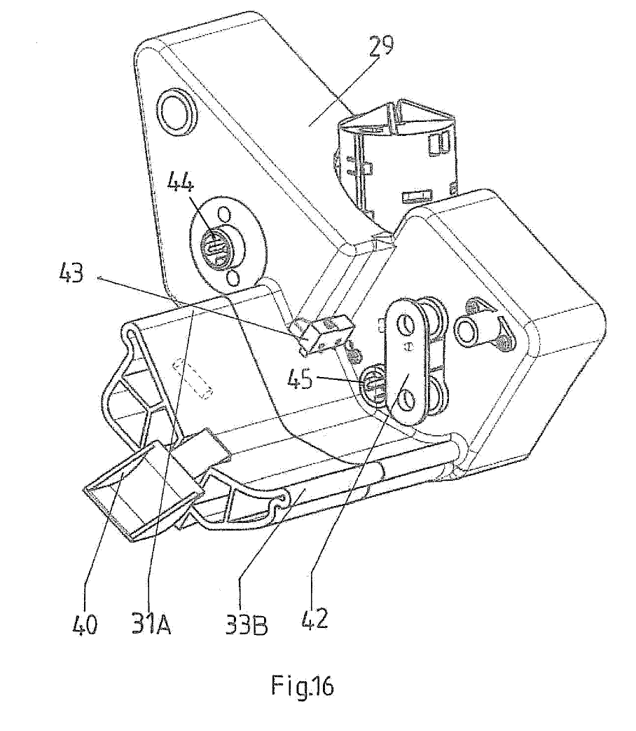

FIG. 15 is an alternative embodiment as seen in a view analogous to FIG. 8;

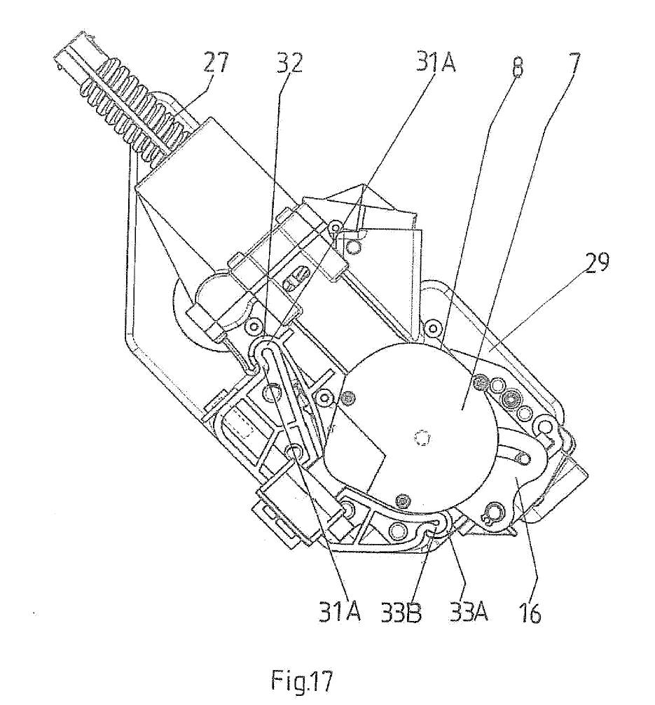

FIG. 16 shows the support of FIG. 15 without the brewing unit;

FIG. 17 is a side view of the embodiment of FIG. 15.

The drawing shows a brewing unit and its essential components. A brewing unit of this type is a component of a coffee machine and functions in particular to prepare coffee beverages or espresso.

The brewing unit has a brewing chamber 1 that holds ground coffee. In addition, the brewing unit has components for compacting the ground coffee located in the brewing chamber 1 and for ejecting the wet residual coffee grounds from the brewing chamber 1. In addition, unillustrated connections are provided to supply hot water and to drain off the coffee filtrate.

The brewing chamber 1 is comprised of a stationary immovably mounted cylinder 2 that has a fill opening 3 for ground coffee on its upper side near a first cylinder end. A piston 4 serves for compacting the ground coffee in the brewing chamber 1, and is mounted on the first end of the cylinder 2 for axial movement by a first actuator 44 (FIG. 16). In the fill position of FIG. 6 it unblocks the fill opening 3 and in the brewing position of FIG. 5 it is moved by a second actuator 45 (FIG. 16) beyond the fill opening 3 toward an end plate 5 provided at a second end of the cylinder 2. In the fill position and in the brewing position, the end plate 5 covers and closes the second end of the cylinder 2, whereas in the eject position this plate 5 unblocks the second end of the cylinder 2. In the eject position with the end plate 5 in the open position, the piston 4 is moved by the first actuator to an eject position further toward the second end of the cylinder 2 to expel used coffee grounds from this second end. The piston 4 and the end plate 5 can be moved back to the closed position after ejecting the wet residual coffee grounds. The unillustrated connections for the hot water supply and filtrate drain are provided on the piston 4 and on the end plate 5.

The end plate 5 is pivoted externally on the cylinder 2 near the cylinder's second end. The end plate 5 can be pivoted about a first pivot 6 from the closed position of FIG. 1 or 3 to the open position of FIG. 2.

Compartments 8 that are closed by covers 7 are provided laterally on the outside of the cylinder 2, in each of which compartments one gear wheel 9 is rotatably supported. The pivot bearing is indicated by 10. The gear wheels 9 mesh with a geared shaft 11 supported in a housing pocket 12, and having a coupling part 13 projecting axially from the housing pocket 12. A slot 14 is provided in each housing component 8 to allow the gear shaft 11 to engage the respective gear wheel 9.

Coupling plates 16 are pivoted eccentrically to the gear wheels 9 at respective pivots 15, each pass through a radial slot 17 of the respective compartment 8, and are each pivoted at a certain spacing from the respective first pivot 6 at a respective third pivots 18 at an ends that projects from the respective slot 17 of the end plate 5 on the door's side opposite the piston 4. As is shown, in particular in FIG. 3, the second and third pivots 15 and 18, and rotational axes 10 of the gear wheels 9, are located in the closed position of FIG. 1 and FIG. 3 on an imaginary straight line that runs parallel to the longitudinal central axis of the cylinder 2. This achieves the is result in the closed state when the brewing pressure and the applied piston pressure exert a strong force on the end plate 5 that the rods are located at a position in which due to the null point no torque is exerted about the gear wheel axis 10.

When the gear wheels 9 are moved in the rotational direction of arrow 19 by the actuation means, the position of FIG. 2 is reached when the rotational motion is counterclockwise, whereas the position of FIG. 3 is assumed when the rotation is clockwise.

A scraper 20 is furthermore provided on the second end of the cylinder 2 and can be moved perpendicular to the longitudinal central axis of the cylinder 2. This scraper 20 has laterally projecting driver pins 21 that each engage a cam slot 22 of the coupling plates 16 such that beginning with the end plate 5 almost completely opened up to the position with the end plate 5 completely opened, the scraper 20 is positively moved from a position outside the alignment line spanned by the cylinder 2 to a position in the alignment line such that any caked residue adhering to the piston 4 is scraped off. The scraper 20 is positively returned back when the end plate is pivoted back from the position of FIG. 2 to the position of FIG. 3, where the adjustment motion of scraper 20 moves in advance of the closing movement of the end plate 5.

The cam slots 22 in rods 16 are designed so that they retain the position relative to driver pins 21 without skewing forces over the basic path of the coupling plate when it is actuated by the gear wheel 9. Only in the last region of controls slots 22 are these constructed to effect a forced displacement of the scraper in response to continued motion by the end plate 5.

An especially advantageous embodiment is illustrated in FIGS. 5 and 6. Here a pivotal door 23 is installed in the fill opening 3 provided in the form of a passage. It can be moved from a closed position shown in FIG. 5 in which it blocks passage 3 to an open position shown in FIG. 6 in which it unblocks the cross-section of the passage. The door 23 has a driver lever 24 that projects into the cylinder 2 when in the closed position of FIG. 5, and against which parts of the piston 4 are pressed and hold the door 23 in the open position. In the brewing position of FIG. 5, driver pin 24 is released and the door 23 automatically pivots into the locked position of FIG. 5, the closing motion being assisted by a spring.

Another distinguishing aspect is illustrated in FIG. 7. The axially shiftable piston 4 has a circumferential seal 25 and a coffee strainer 26 at the end on its side facing the end plate 5, which strainer is integrally molded into the material of the piston 4. This enables the overall length of the piston to be minimized. The piston 4 is screwed onto the piston rod 27 such that this securement simultaneously secures a crema valve 28 installed therein.

A further distinguishing aspect is illustrated in FIGS. 8 through 12.

In this embodiment, a closed support housing 29 is provided in which the drive motors serving as actuators are mounted. Connecting components of the actuators project from a side of housing 29. This is not shown in the drawing. The brewing unit as a whole can be installed on the housing 29 perpendicular to the center longitudinal axis of the brewing chamber, with the result that coupling parts 13, 30 for the piston actuators or the end plate actuator engage the connecting parts of the actuators. The housing also has a bearing rod 31 to which the brewing unit can be attached by a corresponding hook element 32 and can be slid along the bearing rod 31. In addition, the housing 29 has a guide face 33 a certain spacing from the rod 31, along which cam the brewing unit can be slid into the intended installation position, as indicated by arrow 34 in FIG. 8. Detent-locking means or releasable attachment means are preferably provided to secure it in the intended position.

Another distinguishing aspect is illustrated in FIGS. 11 and 12. A piston rod 27 of the piston 4 is a threaded spindle. A drive gear 35 is supported by a spindle nut on the threaded spindle so at to engage a worm gear 36 provided in a housing pocket 37 of the brewing unit housing. A coupling part of the worm gear 36 projects from the housing part 37 and is plug-in-connected to the drive shaft of a motor provided in the support housing 29 when in the intended installation position.

FIGS. 13 and 14 show a variant. A pin 39 provided here in the compartment 8 interacts with a hook element 38 at the end of each plate 16. The hook 38 projects from the coupling plate 16 at its end above the pivot. The hook 38 is removed from pin 39 when the end plate 5 is opened. When the gear wheel 9 is appropriately rotated, the end of coupling plate 16 linked at the second pivot 15 is moved so that the hook 38 grabs over the pin 39 as shown in FIG. 14. This position achieves the result that the operational forces acting on the mechanism during brewing are resisted and a secure closed position is achieved for the end plate 5.

FIGS. 15 through 17 show another variant. In this embodiment, where the view resembles that of FIG. 8, the bearing rod 31 has been replaced by a bearing cam 31A. The guide face 33 has been replaced by a guide face 33B. In analogous fashion, the brewing unit has both a hook 32 to interact with the bearing cam 31A and a hook 33A that interacts with guide face 33 B. This then results in producing a dovetail-like guide by which reliable guiding of the brewing unit to housing 29 is achieved along with a reliable positioning in the intended position as shown in FIG. 15. A spring-loaded lever 40 provided as the securing element for the operational position lever is pushed by the spring force into the intended position shown in FIGS. 15 and 16 of the drawing. When the brewing unit is mounted on the housing 29, the upward-projecting end of the lever 40 is pressed down against the spring force, thereby enabling the brewing unit to be inserted into the intended position. After reaching the intended position, the lever 40 pivots up into the operating position as shown for example in FIG. 15 in which the top end 41 of the lever 40 contacts the side of the brewing unit, thus preventing any lateral movement by the brewing unit.

In addition, a spring-loaded plate 42 is provided on the housing 29 to ensure that the brewing unit is seated in a defined manner in the intended position, against which plate 42 the brewing unit is pressed such that plate 42 rests under the spring force on the side of the brewing unit opposite lever 40.

In this embodiment, the brewing unit is inserted laterally into the housing 29. Any movement in directions other than the insertion direction is prevented by corresponding elements 31A, 32, 33B, and 33A. Shortly before the end position, the brewing unit strikes the spring-loaded plate 42 pressed back against the spring force toward the housing 29 to the lock-in position for the brewing unit. The end position is achieved by the lever 40 locking into the retaining cam 41 so that the brewing unit is retained securely in the intended position. Whenever the brewing unit is to be removed, the lever 40 is moved by cam 41 such that cam 41 shifts below so that the brewing unit is moved, for example, by the spring-loaded plate 42 and can be removed by hand from the guide face.

In FIG. 16, a microcircuit 43 is provided on the housing 29 and is connected to the controller for the housing 29 or for the coffee machine equipped therewith and actuated by the coupling plate 16 or by one of hooks 38 when the end plate 5 is located in the correct closed position.

The invention provides an extremely functional, operationally reliable, and durable brewing unit.

The invention is not restricted to the embodiments but can be varied in multiple ways within the scope of the invention.

All of the novel individual and combined features disclosed in the description and/or drawing are considered to be essential to the invention.

We claim:

1. A brewing unit for a coffee machine, the unit comprising:
a cylinder forming a brewing chamber that holds ground coffee and that has first and second ends and a lateral fill opening adjacent the first end;
an end plate pivotal on the cylinder between an end-plate axis between a closed position covering and closing the second end and an open position offset therefrom with the second end open;
a piston axially movable in the cylinder away from the first end of the cylinder past the fill opening to compact coffee introduced through the fill opening at the second end in a brewing position and from the brewing position toward the second end in the open position of the end plate into an eject position to eject the used ground coffee from the brewing chamber;
a pair of wheels flanking the cylinder at the second end and rotatable about a common wheel axis parallel to the end-plate axis;
respective coupling plates each having an inner end pivoted on the wheel about an eccentric axis parallel to and offset from the wheel axis and an outer end pivoted on the end plate about an actuating axis offset from the end-plate axis and parallel thereto; and
a drive coupled to both wheels for synchronously rotating same with the eccentric axes aligned axially of the wheel axis between one position with the wheel axis, actuating axis, and eccentric axis generally coplanar and the wheel axis between the eccentric axis and the actuating axis and the end plate in the closed position and another position with the eccentric axis between the wheel axis and the actuating axis and the end plate in the open position.

2. The brewing unit defined in claim 1, further comprising:
a scraper shiftable across the second end of the cylinder and having projecting ends spaced axially of the end-plate axis, the coupling plates being formed with cam slots each receiving a respective one of the projecting ends and shaped such that movement of the end plate from the closed to the open position took place synchronously with movement of the scraper across the second end in one direction to scrape ground coffee off the end of the piston in the eject position thereof and for synchronous movement of the scraper across the second end in an opposite direction on movement of the end plate from the open to the closed position.

3. The brewing unit defined in claim 1, further comprising:
a door in the fill opening pivotal between a blocking position closing the opening and a fill position unblocking the opening; and
an element on the door engageable with the piston for shifting the door into the blocking position on movement of the piston from the first end to the second end and for shifting the door into the fill position on movement of the piston from the second end to the first end, whereby the door is in the blocking position when the piston is in the brewing position.

4. The brewing unit defined in claim 3, further comprising
a spring urging the door into the blocking position.

5. The brewing unit defined in claim 1, wherein the piston has a coffee strainer on its face turned toward the second end and is provided with a crema valve behind the strainer connectable to a hot-water supply line.

6. The brewing unit defined in claim 1, further comprising:
a housing provided with a guide pin and a guide face offset therefrom;
first and second motors in the housing having drive couplings projecting from the housing parallel to the guide pin and to the guide face, the cylinder being formed with a hole extending perpendicular the cylinder and fittable over the pin with a surface of the cylinder flatly engaging the guide face in to an installed position of the cylinder on the housing, the drive of the wheels having a coupling element engageable with one of the coupling elements of the housing in the installed position; and
a drive for shifting the piston having a coupling element engageable with the other of the coupling elements of the housing in the installed position.

7. The brewing unit defined in claim 6, further comprising
a spring loaded detent releasably securing the cylinder in the installed position.

8. The brewing unit defined in claim 1 wherein the piston has a piston rod formed as a threaded spindle, the unit further comprising:
an internally threaded and externally toothed gear threaded on the spindle and axially fixed in the cylinder, whereby rotation of the toothed gear axially shifts the piston; and
a worm gear on the cylinder meshing with the toothed gear to rotate same and having an end projecting from the cylinder for releasable connection with a coupling element.

9. The brewing unit defined in claim 1, wherein the cylinder has a pair of gear compartments laterally flanking the cylinder, holding the wheels, and each formed with a slot through which the coupling plate extends.
